(19) United States
(12) Patent Application Publication
(10) Pub. No.: US 2011/0068201 A1
(43) Pub. Date: Mar. 24, 2011

(54) BUILD-UP MINIMIZING SPRAY GUN TIP

(76) Inventors: Joseph E. Tix, Hastings, MN (US); Mark T. Weinberger, Mounds View, MN (US); Christopher J. Pellin, Burnsville, MN (US)

(21) Appl. No.: 12/992,447

(22) PCT Filed: May 1, 2009
(86) PCT No.: PCT/US09/42457

§ 371 Date: Nov. 12, 2010

Related U.S. Application Data
(60) Provisional application No. 61/052,833, filed on May 13, 2008.

(51) Int. Cl. B05B 1/00

(52) U.S. Cl. 239/589

(57) ABSTRACT

The advantage of this construction is that the time between manual cleanings of the frontal area of the gun can be lengthened or eliminated. The spray gun utilizes high pressure air forced through thin openings and that surround the spray tip, to eliminate the eddies in the air flow around the frontal area of the spray gun. One concentric thin opening surrounds the spray tip and is directed parallel to the direction of spray. With a second concentric thin opening, the air is directed at an angle of about 55 degrees relative to the axis or direction of spray.

### TECHNICAL FIELD

This application claims the benefit of U.S. Application Ser. No. 61/052,833, filed May 13, 2008, the contents of which are hereby incorporated by reference.

### BACKGROUND ART

Spray guns, particularly for the application of fast setting materials such as polyurethanes and polyureas have traditionally been prone to the build-up of sprayed material on the front of the gun which requires laborious cleaning by the operator.

### DISCLOSURE OF THE INVENTION

The purpose of this invention is to prevent build-up of sprayed material on the frontal surface of spray guns.

The instant invention utilizes high pressure air forced through thin openings that surround the spray tip, to eliminate the eddies in the air flow around the frontal area of the spray gun. Without this technology the eddies spin towards the frontal area of the gun, bringing small particulates back to the frontal area of the gun where they can build-up and eventually effect the spray pattern. One concentric thin opening surrounds the spray tip similar to the current spray applicators on the market today and is directed parallel to the direction of spray. With a second concentric thin opening, the air is directed at an angle of about 55 degrees relative to the axis or direction of spray. The eddies are forced to develop further away from the frontal area of the gun, where the eddies can not deposit the particulates on the frontal area of the spray gun.

The advantage of this construction is that the time between manual cleanings of the frontal area of the gun can be lengthened or eliminated. This allows operator to be more efficient.

These and other objects and advantages of the invention will appear more fully from the following description made in conjunction with the accompanying drawings wherein like reference characters refer to the same or similar parts throughout the several views.

### BRIEF DESCRIPTION OF DRAWINGS

FIG. 1 is a cross-section of the front end of a spray gun embodying the instant invention.

### BEST MODE FOR CARRYING OUT THE INVENTION

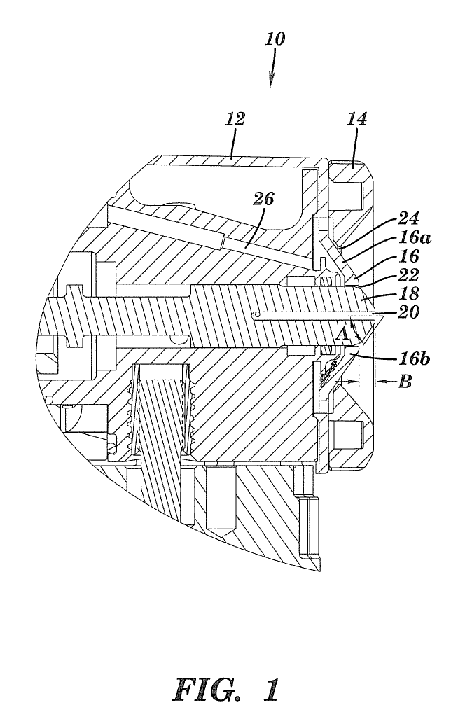

In spray tip assembly of the instant invention, generally 10, is comprised of a housing 12, a retaining ring 14 threadedly attached to housing 12, and an air cap 16 having a conical face and surrounding a spray tip 18 having a fluid passage 20 therein which runs longitudinally along the axis of the tip 18. A passage 26 supplies pressurized air to the tip assembly 10 where it can exit through two openings which are concentric about tip 18. The first concentric opening 22 is formed between tip 18 and the central opening in air cap 16. The width of the opening 22 in the preferred embodiment is about 0.005 inches. A second concentric opening 24 is formed between retaining ring 14 and air cap 16 and in the preferred embodiment has a width of about 0.015 inches. Also in the preferred embodiment, the conical face 16a of air cap 16 has an angle (designated by A in FIG. 1) of about 55 degrees relative to the axis formed by passage 20 and the center 16 of air cap 16 is spaced backwards a distance (designated by B in FIG. 1) of about 0.302 inches from the tip of spray tip 18.

The instant invention utilizes high pressure air forced through thin openings that surround the spray tip, to eliminate the eddies in the air flow around the frontal area of the spray gun. Without this technology the eddies spin towards the frontal area of the gun, bringing small particulates back to the frontal area of the gun where they can build-up and eventually effect the spray pattern. One concentric thin opening surrounds the spray tip similar to the current spray applicators on the market today and is directed parallel to the direction of spray. With a second concentric thin opening, the air is directed at an angle of about 55 degrees relative to the axis or direction of spray. The eddies are forced to develop further away from the frontal area of the gun, where the eddies can not deposit the particulates on the frontal area of the spray gun.

It is contemplated that various changes and modifications may be made to the spray gun tip without departing from the spirit and scope of the invention as defined by the following claims.

1. A spray gun for fast setting plural component materials and having a spray tip having an axis and a first concentric thin opening surrounding said spray tip directing air parallel to said axis, the improvement comprising a second concentric thin opening outside of said first concentric thin opening directing air at an angle of about 55 degrees relative to said axis.
